(19) United States
(12) Patent Application Publication
(10) Pub. No.: US 2021/0335157 A1
(43) Pub. Date: Oct. 28, 2021

(54) ADVERTISING INTERCONNECTION SYSTEM FOR HUB ROTATION IMAGING

(71) Applicant: CITIC Dicastal CO., LTD., Qinhuangdao (CN)

(72) Inventors: Minglei LI, Qinhuangdao (CN); Shiwen XU, Qinhuangdao (CN); Yao DAI, Qinhuangdao (CN); Shaoqian WANG, Qinhuangdao (CN); Weidong LIU, Qinhuangdao (CN); Xi LI, Qinhuangdao (CN)

(21) Appl. No.: 17/172,872

(22) Filed: Feb. 10, 2021

(30) Foreign Application Priority Data
Apr. 28, 2020 (CN) 202010348378.6

(51) Int. Cl. G09F 21/04; G09F 9/30; H04W 4/80; H04L 29/08

(52) U.S. Cl. CPC G09F 21/045; H04L 67/12; H04W 4/80; G09F 9/30

(57) ABSTRACT

An advertising interconnection system for hub rotation imaging includes a hub rotation imaging apparatus mounted on a hub and a communication component mounted on the hub and connected to the hub rotation imaging apparatus. The communication component includes a low-power short-distance communication component that can communicate between adjacent hubs, and a long-distance wireless communication component which is installed on at least one hub, and can communicate with the low-power short-distance communication component and establish a communication connection with a server through a base station.

### CROSS-REFERENCE TO RELATED APPLICATIONS

The present application claims benefit of Chinese Patent Application No. 202010348378.6, filed on Apr. 28, 2020, the contents of which are hereby incorporated by reference in their entirety.

### BACKGROUND

In an intelligent advertising system based on rotation imaging of a hub, a hub rotation imaging apparatus mounted on the hub needs to receive data and control instructions issued by an advertising system control platform, and performs corresponding display. Therefore, how to realize advertising interconnection of hub imaging becomes a problem to be urgently solved.

### SUMMARY

The present disclosure relates to the field of vehicles, and specifically to an advertising interconnection system for hub rotation imaging.

In view of this, the present disclosure aims to propose an advertising interconnection system for hub rotation imaging, which can efficiently and practically realize advertising interconnection of hub imaging, and meet multiple practical needs.

In order to achieve the above objective, the technical solution of the present disclosure is implemented as follows:

An advertising interconnection system for hub rotation imaging, including a hub rotation imaging apparatus mounted on a hub and a communication component mounted on the hub and connected to the hub rotation imaging apparatus;

the communication component includes a low-power short-distance communication component that can communicate between adjacent hubs, and a long-distance wireless communication component which is installed on at least one hub, and can communicate with the low-power short-distance communication component and establish a communication connection with a server through a base station.

In some embodiments, the communication component includes a processor unit, which can drive the long-distance wireless communication component and the low-power short-distance communication component to communicate.

In some embodiments, the long-distance wireless communication component can receive instructions issued by the server through the base station.

In some embodiments, the long-distance wireless communication component can exchange data with the server through the base station.

In some embodiments, the communication component can transmit data monitored by the hub rotation imaging apparatus to the server.

In some embodiments, the server can determine driving information and location information of a vehicle, and perform at least one of issuing the instructions or transferring files to the communication component.

Compared with the prior art, the advertising interconnection system for hub rotation imaging according to the present disclosure has the following advantages:

The advertising interconnection system for hub rotation imaging according to the present disclosure reduces energy consumption by arranging a communication component combining a low-power short-distance communication component and a long-distance wireless communication component on a hub, and establishes communication connections between adjacent hubs and between a hub and a server, which can efficiently and practically realize advertising interconnection of hub imaging and meet multiple practical needs.

### BRIEF DESCRIPTION OF THE DRAWINGS

The accompanying drawing constituting a part of the present disclosure is used for providing a further understanding of the present disclosure, and the schematic embodiments of the present disclosure and the descriptions thereof are used for interpreting the present disclosure, rather than constituting improper limitations to the present disclosure. In the drawing:

FIG. 1 is a schematic diagram of an advertising interconnection system for hub rotation imaging according to the present disclosure.

### DETAILED DESCRIPTION

It should be noted that the embodiments in the present disclosure and the features in the embodiments can be combined with each other without conflicts.

The technical solutions of the present disclosure will be described clearly and completely with reference to the accompanying drawing and in combination with the embodiments. Apparently, the described embodiments are part of, not all of, the embodiments of the present disclosure. Based on the embodiments of the present disclosure, all other embodiments obtained by those of ordinary skill in the art without any creative effort shall fall within the protection scope of the present disclosure.

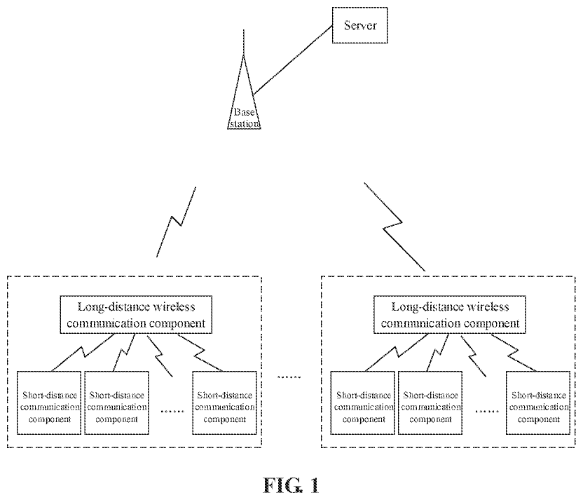

In advertising interconnection system for hub rotation imaging according to an embodiment of the present disclosure will be described with reference to FIG. 1 and in conjunction with the embodiments.

An advertising interconnection system for hub rotation imaging mainly includes a server, a base station, and a communication component installed on a vehicle hub.

The communication component includes a long-distance wireless communication component and a low-power short-distance communication component. In particular, in terms of a vehicle, a long-distance wireless communication component is installed on at least one hub of each vehicle, a low-power short-distance communication component is installed on each hub of each vehicle, and each communication component is driven by a processor unit. The long-distance wireless communication component of each vehicle establishes a connection with the server through the base station to receive instructions and exchanges data. The low-power short-distance communication component on the hub where the long-distance wireless communication component of each vehicle is located establishes a connection with the low-power short-distance communication component on each remaining hub of the vehicle to exchange data.

The server can receive various sensor data uploaded by the communication component of each vehicle, and infer data such as driving information and location information of the vehicle; the server can also issue single or multiple instructions/transfer files to the communication component of each vehicle individually or in batches; and the server can also simultaneously issue the same instruction or file to the communication components of multiple vehicles.

In some embodiments, an advertising interconnection system for hub rotation imaging, referring to FIG. 1, includes a network server, a base station, and a vehicle installed with at least one long-distance wireless communication component.

Several hubs of each vehicle form a set of nodes, a long-distance wireless communication component and a low-power short-distance communication component are installed on one of the hubs, and only low-power short-distance communication components are installed on the remaining hubs. Taking a vehicle installed with four wheels as an example, the four wheels are a set of nodes, and thee of the hubs are set as slaves equipped with low-power short-distance communication components, such as Bluetooth communication components, and zigbee (a wireless network protocol for low-speed and short-distance transmission); the other hub is set as the host, which is equipped with a short-distance communication component (such as Bluetooth, or zigbee) and a long-distance wireless communication component, such as a general ground mobile 3G/4G/5G/NB-IoT communication component; and the low-power short-distance communication components and the long-distance wireless communication component are driven by a processor unit, such as an ARM (Advanced RISC Machines, a 32-bit reduced instruction set processor architecture) kernel single-chip microcomputer and the like with the function of driving the low-power short-distance communication components and the long-distance wireless communication component. In the set of nodes of this vehicle, the host and the other three slaves communicate and interact through respective low-power short-distance communication components. The host is responsible for collecting various data or demand information that each slave needs to report to the server, such as sensor data of the hubs, and distribute the data or instructions obtained from the server to each slave. The host in the set of nodes communicates with the base station through the long-distance wireless communication component, establishes a connection with the server, reports the information of the host itself and the information collected from each slave to the server, and acquires data information or instruction information issued by the server.

The server on the network side establishes a connection with the long-distance wireless communication component of the host of each vehicle through the base station to collect data information and issue data and instruction information. The server can obtain the sensor information of the hubs, and calculate the running status and geographic location of the hubs, and the like. According to actual needs, the server can send instructions and transfer files to the hubs in batches. The instructions and files can be single or multiple. The server can also simultaneously issue the same instructions/files to multiple sets of nodes.

The server can automatically control the multiple sets of nodes according to system settings, for example, set the hubs of each vehicle in a designated area to play the same video content at the same time; or set all of the hubs of vehicles on a highway to display notification content at the same time, and the like.

In some embodiments, one or more slaves in a vehicle can also be set as a backup host, especially in a vehicle scenario such as a heavy-duty truck, a proper amount of backup can ensure the reliability of the Internet-of-vehicles system. The backup host is the same as the host, equipped with a low-power short-distance communication component and a long-distance wireless communication component. When the host is normal, the backup host works in a slave mode. Like other slaves, the backup host reports sensor data to the host through the low-power short-distance communication component thereof, and receives distributed data and instructions from the host, and the like.

When the host in the set of nodes of the vehicle fails to perform host functions, the backup host is switched to a host mode and becomes a new host which establishes a communication connection with the network side, reports data and receives data instructions and the like by the long-distance wireless communication component thereof; and collects data from each slave and distributes data instructions to each slave by the low-power short-distance communication component thereof.

Host failures are roughly divided into two levels, in which the second-level failure is that the long-distance wireless communication component fails and cannot communicate. At this time, the original host is switched to work in the slave mode, and communicates with the new host through its short-distance communication component and the first-level failure is that both the long-distance wireless communication component and the low-power short-distance communication component fail and cannot communicate normally. At this time, the communication function of the original host is down, and the new host reports the status of the first-level failure of the original host to the server through the long-distance wireless communication component.

When the original host that fails is restored, the new host and the original host can determine, by means of a negotiation mechanism, whether to maintain the current working state, restore to the original working state, or restore to the original working state after a certain time.

When the original host that fails is restored, the original host can also report the failure restoration to the server through its long-distance wireless communication component, and then the server determines which node (the original host or the current host) in the set of nodes serves as next host.

In some embodiments, one or more slaves in a vehicle are set as a backup host(s). The backup host is the same as the host, equipped with a low-power short-range communication component and a long-range wireless communication component. The switching between the host and the backup host is no longer on the basis of whether the current host fails, the server sets the specific working mechanism of the main/backup host, and directs the switching of working modes of the current host and the backup host through the issuance of instructions.

This embodiment can enhance the system reliability of the Internet of vehicles.

The configurations of the above embodiments can be flexibly arranged according to the emphasis of actual applications to meet different practical needs.

Compared with the prior art, the advertising interconnection system for hub rotation imaging according to the present disclosure has the following advantages:

The advertising interconnection system for hub rotation imaging according to the present disclosure reduces energy consumption by arranging a communication component combining a low-power short-distance communication component and a long-distance wireless communication component on a hub, and establishes communication connections between adjacent hubs and between a hub and a server, which can efficiently and practically realize advertising interconnection of hub imaging and meet multiple practical needs.

In addition, the hub nodes are simplified, and the nodes on each vehicle are controlled hierarchically. The network server acquires information of a single node, controls data of the single node, controls multiple nodes in batches, and automatically controls the set of nodes according to internal logics.

In the description of the present disclosure, it should be understood that the terms “center”, “longitudinal”, “transverse”, “front”, “rear”, “left”, “right”, “vertical”, “horizontal”, “top”, “bottom”, “inner”, “outer”, and the like indicate orientations or positional relationships based on the drawings. The terms are only for description convenience of the present disclosure and simplification of the description, but do not indicate or imply that the pointed apparatuses or elements must have specific orientations or be constructed and operated in specific orientations. Therefore, the terms should not be understood to limit the present disclosure.

Furthermore, the terms “first” and “second” are only for the sake of description, and cannot be understood as indicating or implying the relative importance or implicitly indicating the quantity of the indicated technical features. Thus, the features defined with “first” and “second” may explicitly or implicitly include one or more of these features. In the description of the present disclosure, “a plurality of” means at least two, e.g., two, three, etc., unless otherwise specified.

In the present disclosure, unless otherwise specified and defined, the terms “mounted”, “joined”, “connected”, “fixed” and the like should be understood in a broad sense, for example, being fixedly connected, detachably connected, integrated; mechanically connected, electrically connected, mutually communicated; directly connected, indirectly connected by a medium, communication of interiors of two components or interaction of two components. A person of ordinary skill in the art could understand the specific meanings of the above terms in the present disclosure according to specific circumstances.

The foregoing descriptions are merely preferred embodiments of the present disclosure, but are not intended to limit the present disclosure. Any modification, equivalent substitution, improvement and the like made within the spirit and principle of the present disclosure shall fall within the protection scope of the present disclosure.

1. An advertising interconnection system for hub rotation imaging, comprising a hub rotation imaging apparatus mounted on a hub and a communication component mounted on the hub and connected to the hub rotation imaging apparatus;
the communication component comprises a low-power short-distance communication component that can communicate between adjacent hubs, and a long-distance wireless communication component which is installed on at least one hub, and can communicate with the low-power short-distance communication component and establish a communication connection with a server through a base station.

2. The advertising interconnection system for hub rotation imaging according to claim 1, wherein the communication component comprises a processor unit, which can drive the long-distance wireless communication component and the low-power short-distance communication component to communicate.

3. The advertising interconnection system for hub rotation imaging according to claim 1, wherein the long-distance wireless communication component can receive instructions issued by the server through the base station.

4. The advertising interconnection system for hub rotation imaging according to claim 1, wherein the long-distance wireless communication component can exchange data with the server through the base station.

5. The advertising interconnection system for hub rotation imaging according to claim 1, wherein the communication component can transmit data monitored by the hub rotation imaging apparatus to the server.

6. The advertising interconnection system for hub rotation imaging according to claim 5, wherein the server can determine driving information and location information of a vehicle, and perform at least one of issuing instructions or transferring files to the communication component.
